(19) United States
(12) Patent Application Publication
(10) Pub. No.: US 2014/0346383 A1
(43) Pub. Date: Nov. 27, 2014

(54) METHOD FOR MANUFACTURING A MAGNETIC SEPARATION FOR A SOLENOID VALVE

(71) Applicant: ROBERT BOSCH GMBH, Stuttgart (DE)

(72) Inventors: Juergen Graner, Sersheim (DE); Martin Maier, Moeglingen (DE); Nikolaus Hautmann, Ditzingen (DE); Ralf Diekmann, Schwieberdingen (DE)

(21) Appl. No.: 14/350,751

(22) PCT Filed: Sep. 26, 2012
(86) PCT No.: PCT/EP2012/068990

§ 371 Date: Apr. 9, 2014

(30) Foreign Application Priority Data
Oct. 18, 2011 (DE) 10 2011 084 724.3

(51) Int. Cl. F16K 31/06; H01F 41/00

(52) U.S. Cl. CPC F16K 31/0675; H01F 41/00
USPC 251/129.15; 29/602.1

(57) ABSTRACT

A method for manufacturing a solenoid valve or a fuel injector, including a sleeve, a valve needle situated inside the sleeve in a radial direction and guided so as to slide, a solenoid coil situated outside of the sleeve in a radial direction, a magnetic core situated inside the sleeve in a radial direction, and a magnet armature situated inside the sleeve in a radial direction, axially opposite to the magnetic core; the magnet armature being situated on the valve needle, the sleeve having a low wall thickness in a thin-walled region situated between the magnet armature and the solenoid coil, the thin-walled region strengthened by a reinforcing element for absorbing radial forces; and a method step, during which, the reinforcing element is deposited onto the sleeve, in the thin-walled region, in a radial direction, outside of the sleeve, using a molten bath or cold gas spraying method.

### FIELD

The present invention is directed to a method for manufacturing a solenoid valve.

### BACKGROUND INFORMATION

In the case of electromagnetically operable solenoid actuators for operating solenoid valves, in particular, of injection valves, it is often useful to position a magnetic coil used for generating a magnetic field, outside of a region through which a fluid, in particular, fuel, flows. This facilitates assembly and prevents, e.g., damage to the lacquer layer of the coil wire by the action of fuel. In order to produce such a dry coil arrangement, metallic sleeves are used, which seal the fuel-filled valve interior in the direction of the coil. In order to withstand the fuel pressure in the interior of the sleeve (e.g., pressures of greater than 200 bar internal pressure), the sleeve must have a sufficient wall thickness.

At the same time, it must be ensured that the magnetic flux may reach the magnetic circuit components situated in the interior (armature, i.e., magnetic armature, and inner pole, i.e., magnet core), from outside the sleeve, in as non-dissipative a manner as possible. This requires a magnetically soft sleeve having a permeability that is as high as possible, thus, good magnetic conductivity. However, a sleeve that is magnetically soft throughout has the disadvantage that a portion of the magnetic flux does not penetrate the inner pole and armature of the magnetic circuit and the air gap situated between them, as desired, but remains in the sleeve. Thus, the magnetic circuit is short-circuited by the sleeve, which causes a marked reduction in the magnetic force obtainable and affects the dynamics of the force build-up and decay.

In order to prevent or limit the short-circuiting of the magnetic circuit, sleeves are used, which have only little or no magnetic conductivity in the region of the armature air gap, that is, in the region between the magnet armature and the inner pole, and have as high a magnetic conductivity as possible in the zones of the radial magnetic flux. Such a “magnetic separation” may be achieved, inter alia, by a multipart construction of the sleeve, in that a spacer made of non-magnetic material is positioned between two magnetically soft sleeve parts. The elements may be joined by different methods, such as welding (e.g., printed publications DE 10 2006 014 020 A1 and DE 102 35 644 A1) or soldering (printed publication DE 43 10 719 A1). Fastening a non-magnetic spacer coated with flexible sealing material (printed publication DE 40 29 278 A1) or influencing the microstructure by local thermal treatment of the sleeve (printed publication DE 10 2006 055 010 A1) are also understood as configuration approaches. Furthermore, the magnetic resistance of the sleeve in the region of the armature air gap may be increased by reducing its wall thickness in this zone.

The described methods are believed to have various disadvantages. In the case of a multipart sleeve, the high expenditure of joining the parts, the test for imperviousness, and the necessary reworking, e.g., due to thermal distortion, are to be regarded as unfavorable. The method of local thermal influencing of the magnetic properties does not allow complete neutralization of the magnetizability of the material, produces an unsharp separation due to the zones of heat influx, and may also cause distortion of the sleeve. In addition, the configuration approach of a reduction in wall thickness, which is the simplest from a standpoint of production engineering, is a rather poor compromise from a functional point of view, since for reasons of strength, a relatively high residual wall thickness is necessary. This limits the effectiveness of the magnetic separation, and consequently, the performance of the solenoid valve.

### SUMMARY OF THE INVENTION

An object of the present invention is to provide an inexpensively producible, high-efficiency magnetic separation for a magnetic circuit for actuating valves.

In comparison with the related art, the solenoid valve of the present invention and the method of the present invention for manufacturing a solenoid valve, according to the alternative independent claims, have the advantage that the low wall thickness of the sleeve in the thin-walled region achieves an optimum magnetic separation effect (without a complete mechanical “magnetic separation”), since the remaining cross-sectional area is already in the state of magnetic saturation in response to comparatively low magnetic flux. It is also advantageous that the wall thickness may be selected to be comparatively low, since the wall thickness assumes only the function of sealing and does not have to transmit the circumferential and axial forces resulting from the internal pressure. It is further advantageous that a reliable seal is ensured, since the sleeve is made of a continuous component part. Furthermore, it is advantageous that the solenoid valve of the present invention may also be used in applications having a very high internal pressure, since the reinforcing element has a high tensile strength and a high stiffness.

Moreover, it is advantageous that the solenoid valve of the present invention may be produced comparatively inexpensively. Since the sleeve is in one piece, no expensive handling, joining and aligning operations are necessary. In addition, the need for an imperviousness test is eliminated. It is also advantageous that the geometry of the magnetic separation is clearly defined and strictly delimited. Furthermore, it is advantageous that both welding of different parts of the sleeve and welding of the sleeve to a reinforcing element are not necessary, since the sleeve is in one piece. By eliminating the need for welding, thermal distortion may be avoided, which means that reworking may be dispensed with. The sleeve may be made of a ferromagnetic material, and the reinforcing element is made of an austenitic (steel) material.

Advantageous embodiments and developments of the present invention may be gathered from the further descriptions herein and the specification, with reference to the drawings.

According to a further refinement, a material having a melting point of greater than 500° C., which may be, a material having a melting point of greater than 1000° C., and particularly may be, a material having a melting point of greater than 1300° C., is used as a material of the reinforcing element. In this manner, the present invention advantageously allows comparatively heavy-duty materials to be used (in particular, in comparison with metals having a comparatively low melting point, such as tin or tin alloys, copper or copper alloys, or the like), which means that (in the case of predetermined sizing, in particular, with regard to its layer thickness on the (radially outer) surface of the sleeve, in particular, in the thin-walled region,) the reinforcing element provides a comparatively high, additional mechanical rigidity.

According to another further refinement, the material of the reinforcing element is a nickel-chromium alloy, in particular, an Inconel alloy or a stainless-steel alloy. In this manner, the high mechanical rigidity may be combined with good workability.

According to another refinement, the material of the reinforcing element forms an austenite crystal structure. By this means, the present invention combines especially good magnetic properties with especially good mechanical properties.

In addition, the present invention may provide that the method have a further method step; during the additional method step and temporally after the first method step, the radially inner surface of the thin-walled region being mechanically processed, for example, by treating the surface using lathing. This embodiment variant including a reworked inner surface of the sleeve and, in particular, of the thin-walled region may be provided, in particular, when a change in the inner or outer diameter of the sleeve near the ends of the thin-walled region is intended.

According to the present invention, the thin-walled region may also be formed near an annular groove of the sleeve. Inexpensive and uncomplicated manufacturing of the solenoid valve is rendered advantageously possible by producing the thin-walled region as an annular groove. Producing the annular groove allows a solenoid valve having the advantages of the solenoid valve of the present invention to be manufactured in a simple manner. The annular groove may be introduced, using a lathing method. As an alternative, other methods of producing the annular groove are also possible.

Further subject matter of the present invention includes a solenoid valve, which is manufactured according to a method of the present invention. In this manner, the solenoid valve may be manufactured particularly inexpensively, but with an especially effective magnetic separation.

According to a further refinement, it is provided that in the thin-walled region, the sleeve have a wall thickness of 100 μm to 800 μm, which may be 100 μm to 300 μm. This comparatively low wall thickness advantageously renders possible an optimum magnetic separation, and through it, prevention of the magnetic short circuit.

Exemplary embodiments of the present invention are represented in the drawings and explained more precisely in the following description. In the different figures, like parts are always denoted by the same reference symbols and are therefore usually labeled or mentioned only once.

### BRIEF DESCRIPTION OF THE DRAWINGS

FIG. 1 shows schematically a section of a solenoid valve according to a first specific embodiment of the present solenoid valve of the present invention.

FIG. 2 shows schematically a portion of the magnetic separation of a solenoid valve of the present invention, according to a specific embodiment.

FIG. 3 shows schematically a portion of the magnetic separation of a solenoid valve of the present invention, according to another specific embodiment.

### DETAILED DESCRIPTION

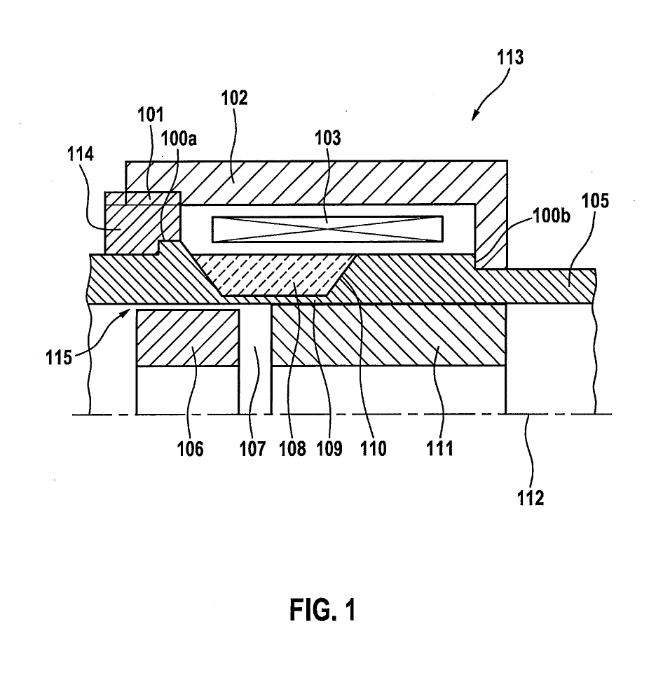

FIG. 1 schematically shows a section of a solenoid valve 113 according to a first specific embodiment. Solenoid valve 113 is, in particular, an injection valve for liquid fuel (the valve needle and restoring spring are not illustrated). The solenoid valve is axially symmetric with respect to axis 112. An armature 106, which is magnetically soft, that is, made of a ferromagnetic material (also referred to below as a magnet armature 106), is supported so as to be able to slide axially, and when coil 103 (also referred to as a solenoid coil 103 in the following) is energized, the armature is pulled up by a magnetically soft inner pole 111 (also referred to in the following as magnetic core 111), due to the resulting magnetic force.

For a large magnetic force, care should be taken that the magnetic flux pass through armature air gap 107 as much as possible. To this end, a valve sleeve 105 (also referred to below as sleeve 105) is provided with an annular groove 110 (also referred to below as groove 110 or thin-walled region 110) near armature air gap 107. Due to the low residual wall thickness 109 (of sleeve 105), this thin-walled region 110 brings about a reduction in the cross-sectional area of valve sleeve 105, which means that the magnetic flux runs almost completely in armature air gap 107 and not unused in sleeve 105.

Valve sleeve 105 is made of a magnetically soft material, in order to conduct the magnetic flux radially from inner pole 111 and across a radial air gap 115, through a solenoid lid 114, to a solenoid jar 102, in as non-dissipative a manner as possible. Valve sleeve 105 also has the task of sealing off the interior from the surroundings. In this context, the fuel pressure in the interior of sleeve 105 is, as a rule, markedly greater than the ambient pressure, which means that sleeve 105 is pressurized and must absorb high radial forces. To strengthen sleeve 105, sleeve 105 is provided with a reinforcing element 108 in thin-walled region 110.

According to the present invention, reinforcing element 108 is applied, using a molten bath spraying method, or using a cold gas spraying method. According to the present invention, in particular, a material having a melting point of greater than 500° C., which may be, a material having a melting point of greater than 1000° C., particularly may be, a material having a melting point of greater than 1300° C., is provided as a material of reinforcing element 108. Reinforcing element 108 absorbs circumferential and radial forces resulting from the pressure, so that sleeve 105 is also mechanically rigid in thin-walled region 110.

According to the specific embodiment represented in FIG. 1, the axial tensile force occurring is transmitted outwards through solenoid lid 114 and solenoid jar 102, past the magnetic separation (that is, past thin-walled region 110). In this specific embodiment, force is introduced from sleeve 105 into the outer component parts via collars 100a, 100b. Solenoid lid 114 and solenoid jar 102 are interconnected by screw threads 101, which means that the transmission of force between these component parts is also ensured.

As an alternative to the use of collars 100a, 100b and the transmission of the axial tensile force past thin-walled region 110 (using solenoid lid 114 and solenoid jar 102 for absorbing the mechanical forces), according to a specific embodiment not shown, the present invention also provides that the material of reinforcing element 108 be configured to be so mechanically rigid, that these axial tensile forces are absorbed by reinforcing element 108.

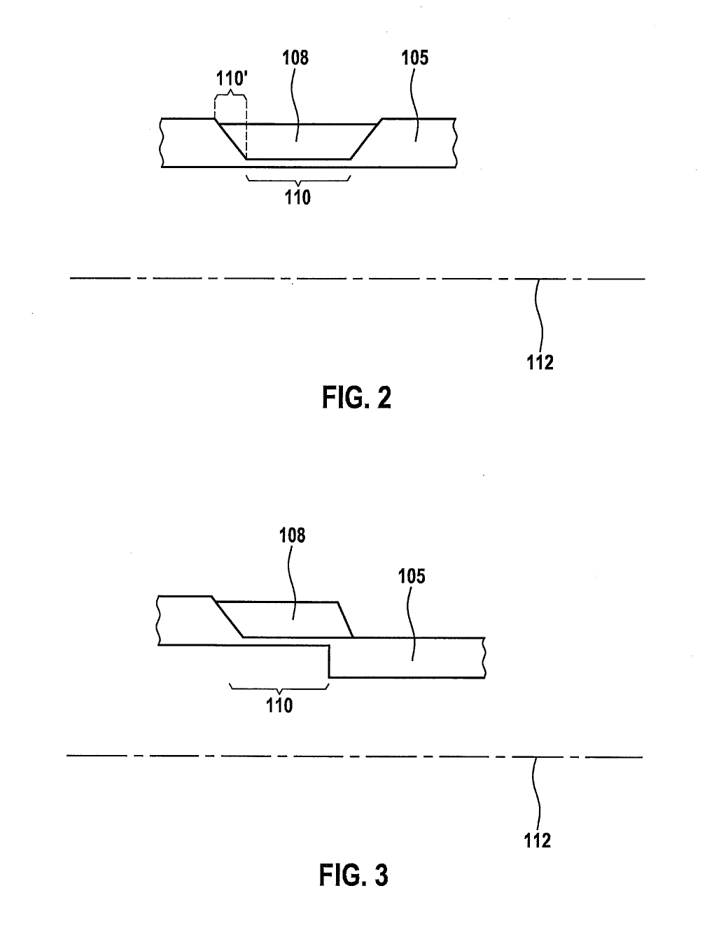

FIGS. 2 and 3 schematically show a portion of the magnetic separation of a solenoid valve 113 of the present invention, according to two specific embodiments.

FIG. 2 schematically shows a portion of solenoid valve 113 according to the first embodiment variant of the present invention also illustrated in FIG. 1; thin-walled region 110 forming an annular groove in sleeve 105. This means that in the axial direction, sleeve 105 has, for example, a constant inner diameter, and also in the axial direction, the sleeve has a lower outer diameter in the area of thin-walled region 110 than in front of and after thin-walled region 110, in the axial direction; it being provided, in particular, that the change in (outer) diameter occur gradually via a beveled region 110′.

However, as an alternative to that, according to a further specific embodiment (also not shown), the present invention may also provide that the change in (outer) diameter occur nearly without a transition (that is, a step change in diameter occurs).

FIG. 3 schematically shows a portion of a solenoid valve 113 according to a second embodiment variant of the present invention; thin-walled region 110 not forming an annular groove in sleeve 105, but being formed in such a manner, that a change in the inner and outer diameter of sleeve 105 is provided in the area of the ends of thin-walled region 110. This means that the inner diameter of sleeve 105 changes in the axial direction at one end of thin-walled region 110, and that the outer diameter of sleeve 105 changes in the axial direction at the opposite end of thin-walled region 110; in the case of this change in diameter as well, either a gradual change in diameter being able to be produced (along the axial direction), or else a step change in diameter. In the illustrated example of FIG. 3, a gradual diameter change is exemplarily shown in the case of the change of the outer diameter (in the left part of the figure), and a step change in diameter is exemplarily shown in the case of the change of the inner diameter (in the right part of the figure). However, the circumstances may also be reversed according to other embodiment variants (not shown), or else in the case of both the change in inner diameter and the change in outer diameter, the gradual diameter change, or else the step change in diameter, may be provided.

In all specific embodiments of the present invention, it is provided that reinforcing element 108 be applied, using a molten bath spraying method or a cold gas spraying method. In the molten bath spraying method, the material of reinforcing element 108 to be applied is heated and applied to the surface to be coated, that is, the outer surface of sleeve 105. In the cold gas spraying method, unmelted or non-heated particles of the material to be applied are highly accelerated and deposited onto the surface to be coated. In both cases, a mechanically rigid layer of the reinforcing element is formed in thin-walled region 110 of sleeve 105. The cold gas spraying method is also known by the name Flamecon of the company, Linde. The molten bath spraying method is also known by the designation MID (molded interconnect devices).

1-8. (canceled)

9. A method for manufacturing a solenoid valve of a fuel injector, the method comprising:
providing a solenoid valve having a sleeve, a valve needle situated inside the sleeve in a radial direction and guided so as to be slideable, a solenoid coil situated outside of the sleeve in a radial direction, a magnetic core situated inside the sleeve in a radial direction, a magnet armature situated inside the sleeve in a radial direction, axially opposite to the magnetic core, wherein the magnet armature is positioned on the valve needle, the sleeve having a low wall thickness in a thin-walled region situated between the magnet armature and the solenoid coil; and
depositing a reinforcing element, the thin-walled region being strengthened by the reinforcing element for absorbing radial forces, onto the sleeve, in the thin-walled region, in a radial direction, outside of the sleeve, using molten bath spraying or cold gas spraying.

10. The method of claim 9, wherein a material having a melting point of greater than 500° C. is used as a material of the reinforcing element.

11. The method of claim 9, wherein the material of the reinforcing element is a nickel-chromium alloy or a stainless steel alloy.

12. The method of claim 9, wherein the material of the reinforcing element forms an austenite crystal structure.

13. The method of claim 9, further comprising:
temporally after depositing the reinforcing element, mechanically processing the radially inner surface of the thin-walled region.

14. The method of claim 9, wherein the thin-walled region is situated near an annular groove of the sleeve.

15. A solenoid valve, comprising:
a solenoid valve having a sleeve, a valve needle situated inside the sleeve in a radial direction and guided so as to be slideable, a solenoid coil situated outside of the sleeve in a radial direction, a magnetic core situated inside the sleeve in a radial direction, a magnet armature situated inside the sleeve in a radial direction, axially opposite to the magnetic core, wherein the magnet armature is positioned on the valve needle, the sleeve having a low wall thickness in a thin-walled region situated between the magnet armature and the solenoid coil; and
a reinforcing element, the thin-walled region being strengthened by the reinforcing element for absorbing radial forces, on the sleeve, in the thin-walled region, in a radial direction, outside of the sleeve;
wherein the reinforcing element is deposited onto the sleeve, in the thin-walled region, in a radial direction, outside of the sleeve, using molten bath spraying or cold gas spraying.

16. The solenoid valve of claim 15, wherein in the thin-walled region, the sleeve has a wall thickness of 100 μm to 800 μm.

17. The solenoid valve of claim 15, wherein in the thin-walled region, the sleeve has a wall thickness of 100 μm to 300 μm.

18. The method of claim 9, wherein a material having a melting point of greater than 1,000° C. is used as a material of the reinforcing element.

19. The method of claim 9, wherein a material having a melting point of greater than 1,300° C. is used as a material of the reinforcing element.

20. The method of claim 9, wherein the material of the reinforcing element is a nickel-chromium alloy, including an Inconel alloy.
